(19) United States
(12) Patent Application Publication
(10) Pub. No.: US 2006/0141119 A1
(43) Pub. Date: Jun. 29, 2006

(54) Purified product of green tea extract and packaged beverage of high-catechin content with the purified product mixed therein

(75) Inventors: Shinji Yamamoto, Sumida-ku (JP); Masaki Iwasaki, Sumida-ku (JP); Naoki Hosoya, Sumida-ku (JP); Eiichi Hoshino, Sumida-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Chuo-ku (JP)

(21) Appl. No.: 11/311,251

(22) Filed: Dec. 20, 2005

(30) Foreign Application Priority Data
Dec. 24, 2004 (JP) 2004-373879

(51) Int. Cl. A23F 3/00

(52) U.S. Cl. 426/597

(57) ABSTRACT

The present invention relates to a packaged beverage of high catechin content, wherein (a) it contains from 55 to 90 wt % of non-polymer catechins based on a solid content of the purified product of green tea extract, and (b) when the purified product of green tea is formed into an aqueous solution containing the non-polymer catechins at a concentration of 1 wt %, the aqueous solution has a b* value of from 39 to 10 as measured by a calorimeter and a total light transmittance (τt) of from 83% to 95% as measured by a turbidometer, and wherein the content of the non-polymer catechin in which the purified product of the green tea is incorporated is from 0.06 to 1.0 wt %. The packaged beverage of the present invention contains non-polymer catechins at a high concentration, has a good flavor and taste, remains free from the formation and settling of precipitates over a long period of time, and is suited for long-term drinking.

### FIELD OF THE INVENTION

This invention relates to a packaged beverage, which contains non-polymer catechins at a high concentration, is good in flavor and taste, does not produce turbidity and remains stable over a long period of time.

### BACKGROUND OF THE INVENTION

As effects of catechins, there have been reported a suppressing effect on the increase of cholesterol and an inhibitory effect on α-amylase activity (JP-A-60-156614 and JP-A-03-133928) For such physiological effects to manifest, it is necessary for an adult to drink 4 to 5 cups of tea a day. Accordingly, there has been a demand for a technology by which catechins can be mixed in beverages at a high concentration in order to facilitate the ingestion of a large amount of catechins. As one of such methods, catechins are added in a dissolved form to a beverage by using a concentrate of green tea extract (JP-A-2002-142677, JP-A-8-298930, and JP-A-8-109178) or the like.

However, in the case where a commercially-available catechin preparation such as a concentrate of green tea extract is used without any further purification, there is a problem that turbidity occurs and the sensation provided when swallowed becomes deteriorated under the influence of components contained in the catechin preparation as time passes, so that such a commercially-available catechin preparation is not suited for the long-term drinking needed to benefit from the physiological effects of catechins.

### SUMMARY OF THE INVENTION

The present invention provides a purified product of green tea extract, wherein (a) the purified product contains from 55 to 90 wt % of non-polymer catechins based on a solid content of the purified product and (b) when the purified product is formed into an aqueous solution containing the non-polymer catechins at a concentration of 1 wt %, the aqueous solution has a b* value of from 39 to 10 as measured by a calorimeter and a total light transmittance (τt) of from 83% to 95% as measured by a turbidometer; and a catechin-containing, packaged beverage containing the purified product of green tea extract at a non-polymer catechin concentration from 0.06 to 1.0 wt %.

### DETAILED DESCRIPTION OF THE INVENTION

The present inventors explored the development of a packaged beverage of high-catechin content which substantially does not produce turbidity, has a good flavor and taste, and is suited for long-term drinking. As a result, it has been found that when its color hue and turbidity is adjusted by a predetermined concentration dilution, a purified product of green tea makes it possible to obtain a packaged beverage of high-catechin content having a good flavor and taste and long-term stability despite its inclusion of catechins at a high concentration.

The packaged beverage according to the present invention contains non-polymer catechins at a high concentration, has a good flavor and taste, does not develop turbidity and remains stable over a long period of time, and is suited for long-term drinking.

The packaged beverage according to the present invention is a packaged high-catechin beverage containing a purified product of green tea extract at a non-polymer catechin concentration of from 0.06 to 1.0 wt %, in which (a) the purified product contains from 55 to 90 wt % of non-polymer catechins based on a solid content of the purified product and (b) when the purified product is formed into an aqueous solution containing the non-polymer catechins at a concentration of 1 wt %, the aqueous solution has a b* value of from 39 to 10 as measured by a colorimeter and a total light transmittance (It) of from 83% to 95% as measured by a turbidometer.

In the present invention, it is necessary to use a purified product of green tea extract which, when formed into an aqueous solution containing non-polymer catechins at a concentration of 1 wt %, has not only a total light transmittance (τt) of from 83% to 95% but also a b* value of from 39 to 10. No sufficient long-term storage stability will be obtainable should anyone of these values fall outside the above-specified ranges.

The concentration of non-polymer catechins in the solid content of the purified product of green tea extract is preferably from 55 to 90 wt %, more preferably from 60 to 75 wt %. When the purified product of green tea extract is formed into an aqueous solution having a non-polymer concentration of 1 wt %, the b* value of the aqueous solution in the L*a*b* color space is from 39 to 10, with a range of from 30 to 10 being preferred. Further, the total light transmittance (τt) of the aqueous solution is from 83% to 95%, with a range from 85% to 95% being preferred.

Such a purified product of green tea extract can be obtained, for example, by purifying a concentrate of green tea extract. The term “green tea extract” as used herein means an extract obtained by extracting tea leaves with hot water or a water-soluble organic solvent. It can also be an extract obtainable by subjecting tea leaves or a preparation thereof to a treatment under a supercritical fluid.

The green tea extract, that is, the extract obtained from green tea leaves can be an extract obtained by extracting from unfermented tea leaves, which are available from the Genus Camellia, for example, C. sinensis, C. assamica or a hybrid thereof, with water, hot water or an aqueous solution containing an extraction aid agent added therein. Such tea leaves include unfermented tea leaves generally called “green tea” such as raw tea leaves, sencha (middle-grade green tea), bancha (coarse green tea), gyokuro (shaded green tea), tencha (powdered tea) and kamairicha (roasted tea). As an extraction method, the extraction can be effected by a conventional method such as a stirring extraction. Upon extraction, however, an organic acid salt such as sodium ascorbate may be added beforehand to water from the viewpoint of oxidation stability. It is also possible to make a combined use of boiling deaeration or an extraction method which is conducted while bubbling an inert gas such as nitrogen gas to eliminate dissolved oxygen, that is, under a so-called non-oxidizing atmosphere.

As the concentrate of green tea extract, it is possible to use one obtained by concentrating an extract of these tea leaves in hot water or a water-soluble organic solvent in a manner known per se in the art, for example, a commercially available concentrate of green tea extract, such as “POLYPHENON” (product of Mitsui Norin Co., Ltd.), “TEAFURAN” (product of ITO EN, LTD.) or “SUNPHENON” (product of Taiyo Kagaku Co., Ltd.).

As an illustrative method for purifying a concentrate of green tea extract to provide a purified product of green tea extract for use in the present invention, a roughly purified product is first prepared (1) by suspending the concentrate in water or a mixture of water and an organic solvent, adding an organic solvent to the resultant suspension, removing the resulting precipitate, optionally treating the thus-prepared solution with activated carbon, acid clay or the like as needed, and then, distilling off the solvent subsequent; (2) by dissolving the concentrate in an organic solvent, adding water or a mixture of water and an organic solvent to the resultant solution, removing the resulting precipitate, and then, distilling off the solvent; or (3) by dissolving the concentrate in water, cooling the resultant solution to 5° C. or lower to cause creaming down, and then, removing the roiled sediment. The roughly purified product is next treated with activated carbon, followed by filtration through a filter. At this time, the used organic solvent may be removed and replaced with water as needed.

Examples of the activated carbon for use in the above method include “KURARAY COAL GL” and “KURARAY COAL GLC” (trade names, products of Kuraray Chemical K.K.; “TAIKO FC”, “TAIKO S”, “TAIKO KS” and “TAIKO SGP” (trade names, products of Futamura Chemical Industries Co., Ltd.); “SHIRASAGI C”, “SHIRSAGI P”, “SHIRASAGI A” and “SHIRASAGI WH2C” (trade names, products of Japan EnviroChemicals, Ltd.). “KURARAY COAL GLC”, “TAIKO SGP” and “SHIRASAGI WH2C” are preferred from the standpoint of ease of handling in production.

Examples of the filter include those having a pore size from 1.0 to 0.1 μm, such as membrane filters and microfiltration membranes (MF membranes), and ultrafiltration membranes (UF membranes). Preferred are microfiltration membranes and ultrafiltration membranes having a pore size of from 0.5 to 0.1 μm.

As a more preferred production process of a purified product of green tea extract, a concentrate of green tea extract can be suspended in a mixed solution of ethanol and water at a weight ratio of from 99/1 to 85/15 and then the suspension is treated with activated clay or the like to obtain a crude catechin preparation, and then, the crude catechin preparation is treated with activated carbon and filtered through a membrane filter. If necessary, ethanol may then be removed, followed by the addition of water.

The term “non-polymer catechins” as used herein is a generic term, which collectively encompasses non-epicatechins such as catechin, gallocatechin, catechingallate and gallocatechingallate, and epicatechins such as epicatechin, epigallocatechin, epicatechingallate and epigallocatechingallate, and indicates catechins which are non-polymers.

The percentage of gallate, which is a generic term and consists of catechin gallate, epicatechin gallate, gallocatechin gallate and epigallocatechin, based on all non-polymer catechins is preferably from 35 to 100 wt % from the standpoint of the effectiveness of the physiological effects of the non-polymer catechins. From the standpoint of the readiness in adjusting the taste, the percentage of gallate is more preferably from 35 to 98 wt %, even more preferably from 35 to 95 wt %.

The packaged beverage according to the present invention contains the non-polymer catechins at a content of from 0.06 to 1.0 wt %, preferably from 0.07 to 1.0 wt %, more preferably from 0.08 to 1.0 wt %, even more preferably from 0.09 to 1.0 wt %, even more preferably from 0.1 to 0.8 wt %, and even more preferably from 0.11 to 0.5 wt %. Insofar as the content of non-polymer catechins falls within the above-described range, a large amount of non-polymer catechins can be taken with ease, and from the standpoint of the color tone of the beverage shortly after its preparation, this content range is also preferred. The concentration of the non-polymer catechins can be adjusted by relying upon the amount of a catechin preparation.

A daily intake of an adult sufficient to exhibit effects for the promotion of accumulated fat oxidation, the promotion of dietary fat oxidation and the promotion of hepatic β-oxidation gene expression is preferably 300 mg or more, more preferably 450 mg or more, even more preferably from 500 mg or more.

Also for the purpose of assuring the daily intake per adult, the packaged beverage according to the present invention contains preferably 300 mg or more, more preferably 450 mg or more, even more preferably 500 mg or more of non-polymer catechins per package.

The packaged beverage according to the present invention is preferably formulated into a non-tea beverage such as a sports drink, isotonic beverage or health drink (nutrition drink). From the standpoint of the flavor and taste of the packaged beverage and the stability of the non-polymer catechins, its pH is set preferably at from 2 to 6.5, more preferably at from 3.0 to 6.5, even more preferably at from 3.5 to 6.5, all at 25° C.

A bitterness suppressor may be mixed in the packaged beverage according to the present invention. As its example, a cyclodextrin or the like is preferred. As the cyclodextrin, an α-, β- or γ-cyclodextrin or a branched α-, β- or γ-cyclodextrin may be used. In the packaged beverage according to the present invention, a cyclodextrin may be contained at from 0.01 to 0.5 wt %, preferably at from 0.01 to 0.3 wt %. Among these cyclodextrins, β-cyclodextrin is more preferred.

To the packaged beverage according to the present invention, it is possible to mix, in addition to the above-described ingredients, additives either singly or in combination as needed depending on the objective of the packaged beverage. These additives may include antioxidants, flavorants, various esters, organic acid salts, inorganic acids, inorganic acid salts, inorganic salts, colorants, emulsifiers, preservatives, seasoning agents, sweeteners, sour seasonings, fruit extracts, vegetable extracts, flower honey extracts, quality stabilizers, and the like.

Examples of the antioxidants include ascorbic acid, EDTA (ethylenediaminetetraacetic acid) and salts thereof, and plant extracts.

Examples of the inorganic acids and inorganic acid salts include phosphoric acid, disodium phosphate, and sodium metaphosphate. These inorganic acids and inorganic acid salts may be contained in an amount of from 0.0001 to 0.5 wt %, with from 0.0001 to 0.3 wt % being preferred, in the beverage.

Examples of the sweeteners include sugar, glucose, fructose, isomerized syrup, glycyrrhizin, stevia, aspartame, fructooligosaccharide, and galactooligosaccharide.

Examples of the sour seasonings include edible acids such as malic acid, citric acid, tartaric acid, and fumaric acid. These sour seasonings may be used to adjust the pH of the packaged beverage according to the present invention. As a pH adjuster, an organic or inorganic, edible acid may be used. These acids can be used either in non-dissociated forms or in the forms of various salts thereof, for example, their potassium or sodium hydrogenphosphates or their potassium or sodium dihydrogenphosphates. As preferred acids, edible organic acids can be mentioned including citric acid, malic acid, fumaric acid, adipic acid, gluconic acid, tartaric acid, ascorbic acid, acetic acid, phosphoric acid, and mixtures thereof. More preferred acids are citric acid and malic acid. These sour seasonings are also useful as antioxidants which stabilize beverage ingredients.

In the packaged beverage according to the present invention, one or more vitamins may be incorporated further. Preferably, vitamin A, vitamin C and vitamin E may be added. Other vitamins such as vitamin D and vitamin B may also be added.

As a container useful for the packaged beverage according to the present invention, a container of an ordinary form can be used similarly to general packaged beverages, such as a molded package made of polyethylene terephthalate as a principal component (a so-called PET bottle), a metal can, a paper container combined with metal foils or plastic films, or a bottle. More preferred is a PET bottle as a transparent container, which is also a preferred container from the view point of its excellent recappability. The term “packaged beverage” as used herein means one that can be consumed without dilution.

The packaged beverage according to the present invention may be produced, for example, by filling the beverage in a container such as a metal can and, when heat sterilization is feasible, conducting heat sterilization under sterilization conditions as prescribed in the Food Sanitation Act (Japan). For those which cannot be subjected to retort sterilization like PET bottles or paper containers, a process is adopted such that the beverage is sterilized beforehand under similar sterilization conditions as those described above; for example, the beverage is sterilized at a high temperature for a short time by a plate-type heat exchanger, is cooled to a prescribed temperature, and is then filled in a container. Under aseptic conditions, additional ingredients may be added to and filled in a beverage-filled container. It is also possible to conduct an operation such that subsequent to heat sterilization under neutral conditions, the pH of the tea beverage is caused to drop back to the acidic side under aseptic conditions.

The following examples further describe and demonstrate embodiments of the present invention. The examples are given only solely for the purpose of illustration and are not to be construed as limitations of the present invention.

### EXAMPLES

Measurement of Catechins

A high-performance liquid chromatograph (model: “SCL-10AVP”, trade name) manufactured by Shimadzu Corporation was used. The chromatograph was fitted with an LC column packed with octadecyl-introduced silica gel, “L-Column, TM ODS” (trade name; 4.6 mm in diameter×250 mm in length; product of Chemicals Evaluation and Research Institute, Japan). A packaged beverage, which had been filtered through a filter (0.8 μm) and then diluted with distilled water, was subjected to chromatography at a column temperature of 35° C. by gradient elution. A 0.1 mol/L solution of acetic acid in distilled water and a 0.1 mol/L solution of acetic acid in acetonitrile were used as mobile phase solution A and mobile phase solution B, respectively. The measurement was conducted under the conditions of 20 μL injected sample quantity and 280 nm UV detector wavelength.

Measurement of b* Values in the L*a*b* Color Space.

Catechin preparations prepared by various methods were formed into aqueous solutions having a non-polymer catechin concentration of 1 wt %, and were measured using a calorimeter “ZE-2000” (trade name, manufactured by Nippon Denshoku Industries, Co., Ltd.).

Measurement of Total Light Transmittances (τt)

The catechin preparations prepared by the various methods were formed into aqueous solutions having a non-polymer catechin concentration of 1 wt %, and were measured using a haze meter (manufactured by Murakami Color Research Laboratory Co., Ltd.).

### Example 1

### Purified Product (1) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 3.75 wt % of activated carbon “KURARAY COAL GLC” (trade name, product of Kuraray Chemical K.K.), the filtrate was subjected to adsorption treatment. Ethanol was driven off by the reduced-pressure heating method, and the remaining solution was adjusted into to an aqueous solution of 22 wt % non-polymer catechin concentration to afford a purified product (1) of the green tea extract.

### Example 2

### Purified Product (2) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. Ethanol was driven off by the reduced-pressure heating method, and the remaining solution was adjusted into an aqueous solution of 22 wt % non-polymer catechin concentration. The aqueous solution was then processed through an ultrafiltration membrane (molecular weight cutoff: 50,000) (product of Asahi Kasei Corporation) to afford a purified product (2) of the green tea extract.

### Example 3

### Purified Product (3) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. By the reduced-pressure heating method, ethanol was driven off to obtain an aqueous solution. The aqueous solution was then subjected to adsorption treatment with activated carbon, “TAIKOFC” (trade name, product of Futamura Chemical Industries Co., Ltd.). The activated carbon was removed with a 0.2-μm membrane filer, and the filtrate was adjusted into an aqueous solution of 22 wt % non-polymer catechin concentration to afford a purified product (3) of the green tea extract.

### Example 4

### Purified Product (4) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. Subsequently, water was added to bring the ethanol/water weight ratio to 60/40, followed by adsorption treatment with 1.8 wt % of activated carbon, “SHIRASAGI P” (trade name, product of Japan EnviroChemicals, Ltd.), based on the weight of the solution. After the activated carbon was removed with a 0.2-μm membrane filer, ethanol was driven off by the reduced-pressure heating method. The remaining solution was adjusted into an aqueous solution of 22 wt % non-polymer catechin concentration to afford a purified product (4) of the green tea extract.

### Comparative Example 1

### Purified Product (5) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. After ethanol was driven off by the reduced-pressure heating method, the remaining solution was adjusted into an aqueous solution of 22 wt % non-polymer catechin concentration to afford a purified product (5) of the green tea extract.

### Comparative Example 2

### Purified Product (6) of Green Tea Extract

In a mixed solution of ethanol and water at a weight ratio of 92.5/7.5, acid clay was dispersed at 6.25 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. Subsequently, water was added to bring the ethanol/water weight ratio to 80/20, followed by adsorption treatment with 1.9 wt % of activated carbon, “SHIRASAGI A” (trade name, product of Japan EnviroChemicals, Ltd.), based on the weight of the solution. After the activated carbon was removed with a 0.2-μm membrane filer, ethanol was driven off by the reduced-pressure heating method. The remaining solution was adjusted into an aqueous solution of 22 wt % non-polymer catechin concentration to afford a purified product (6) of the green tea extract.

### Comparative Example 3

### Purified Product (7) of Green Tea Extract

In a mixed solution of ethanol and water at a weight ratio of 92.5/7.5, acid clay was dispersed at 5.0 wt % based on the weight of the solution. Into the slurry, a powder of a concentrate of green tea extract (“POLYPHENON HG”, trade name; product of Mitsui Norin Co., Ltd.) was added at 12.5 wt % based on the slurry, and the thus-prepared mixture was stirred for 12 hours. Solid matter including acid clay was removed by filtration, and with 1.25 wt % of activated carbon “KURARAY COAL GLC” (trade name, product of Kuraray Chemical K.K.), the filtrate was subjected to adsorption treatment. After ethanol was driven off by the reduced-pressure heating method, the remaining solution was adjusted into an aqueous solution of 22 wt % non-polymer catechin concentration to afford a purified product (7) of the green tea extract.

The b* values of the purified products of green tea extract, which were produced in Examples 1-4 and Comparative Examples 1-3, respectively, in the L*a*b* color space and their total light transmittances (τt) are shown in Table 1.

Using the purified products of green tea extract as produced in Examples 1-4 and Comparative Examples 1-3, respectively, the packaged beverages described in Table 2 were produced. Sterilization was conducted under the following conditions:
Sterilization step: UHT pasteurization of 98° C. (30 seconds) was conducted, followed by hot-pack filling at 87° C.
Turned sterilization: 30 seconds
Pasteurization cycle through a pasteurizer:
75° C. (4 minutes)→59° C. (3 minutes)→49.5° C. (8 minutes)→33° C. (7 minutes).

The following methods were followed to assess their stability with time and their flavors and tastes. The results are also shown in Table 3.

Assessment of Stability with Time

Each packaged beverage was stored at room temperature (25° C.), and an assessment was performed based on the period until the development of a precipitate.

Assessment of Flavor and Taste

Shortly after the production of each beverage, its flavor and taste were assessed by 10 expert panelists with an attention concentrated on any coarse taste which the beverage may have. The assessment was conducted using the following 5-stage scale, and the results are shown as an average score of 10 expert panelists in Table 3.

5: No coarse taste.

4: A coarse taste is slightly sensed.

3: A coarse taste is sensed to some extent.

2: A coarse taste is sensed.

1: A coarse taste is strongly sensed.

TABLE 1

| | | b* value | Total light transmittance (τt) (%) |
|---|---|---|---|
| Ex. | 1 | 10.54 | 94.2 |
| | 2 | 21.05 | 92.3 |
| | 3 | 26.89 | 89.8 |
| | 4 | 36.32 | 83.6 |
| Comp. | 1 | 39.27 | 87.1 |
| Ex. | 2 | 39.07 | 82.7 |
| | 3 | 52.30 | 80.0 |

TABLE 2

| | | Examples | | | | Comparative Examples | | |
|---|---|---|---|---|---|---|---|---|
| | | 1 | 2 | 3 | 4 | 1 | 2 | 3 |
| Sweetener | | 1.20 | 1.20 | 1.20 | 1.20 | 1.20 | 1.20 | 1.20 |
| Sour seasoning | | 0.24 | 0.24 | 0.24 | 0.24 | 0.24 | 0.24 | 0.24 |
| NaCl | | 0.06 | 0.06 | 0.06 | 0.06 | 0.06 | 0.06 | 0.06 |
| KCl | | 0.04 | 0.04 | 0.04 | 0.04 | 0.04 | 0.04 | 0.04 |
| L-ascorbic acid | | 0.03 | 0.03 | 0.03 | 0.03 | 0.03 | 0.03 | 0.03 |
| Cyclic oligosaccharide | | 0.24 | 0.24 | 0.24 | 0.24 | 0.24 | 0.24 | 0.24 |
| Fruit juice | | 0.10 | 0.10 | 0.10 | 0.10 | 0.10 | 0.10 | 0.10 |
| Purified product | (1) | 0.55 | — | — | — | — | — | — |
| of green tea | (2) | — | 0.55 | — | — | — | — | — |
| extract | (3) | — | — | 0.55 | — | — | — | — |
| | (4) | — | — | — | 0.55 | — | — | — |
| | (5) | — | — | — | — | 0.55 | — | — |
| | (6) | — | — | — | — | — | 0.55 | — |
| | (7) | — | — | — | — | — | — | 0.55 |

| | | | | | | | |
|---|---|---|---|---|---|---|---|
| Flavor | 0.2 | 0.2 | 0.2 | 0.2 | 0.2 | 0.2 | 0.2 |
| Deionized water | Balance | Balance | Balance | Balance | Balance | Balance | Balance |
| Total | 100 | 100 | 100 | 100 | 100 | 100 | 100 |

TABLE 3

| | | Assessment of | Assessment of |
|---|---|---|---|
| | | stability with time | flavor and taste |
| Ex. | 1 | No occurrence of | 4.8 |
| | | precipitate | |
| | 2 | No occurrence of | 4.4 |
| | | precipitate | |
| | 3 | No occurrence of | 4.2 |
| | | precipitate | |
| | 4 | No occurrence of | 4.0 |
| | | precipitate | |
| Comp. | 1 | 3 days | 3.2 |
| Ex. | 2 | 2 weeks | 2.4 |
| | 3 | 5 days | 1.5 |

1. A purified product of green tea extract, comprising
from 55 to 90 wt % of non-polymer catechins based on a solid content of said purified product;
wherein when said purified product is formed into an aqueous solution containing said non-polymer catechins at a concentration of 1 wt %, said aqueous solution has a b* value of from 39 to 10 as measured by a calorimeter and a total light transmittance (τt) of from 83% to 95% as measured by a turbidometer.

2. A catechin-containing packaged beverage comprising a purified product of green tea extract as defined in claim 1, wherein the content of the non-polymer catechins is from 0.06 to 1.0 wt %.

3. A catechin-containing packaged beverage according to claim 2, which is a non-tea beverage.

4. A catechin-containing packaged beverage according to claim 2 or 3, which is a sports drink, isotonic drink or health drink.
